(19) United States
(12) Patent Application Publication
(10) Pub. No.: US 2026/0360384 A1
(43) Pub. Date: Nov. 12, 2026

(54) ACOUSTIC MONITORING SYSTEM AND METHOD, CORRESPONDING COMPUTER PROGRAM

(71) Applicant: ORIKIO, BREST (FR)

(72) Inventors: Gilles DEBUNNE, BREST (FR); Jordan CREFF, BREST (FR); Guillaume DEMANGE, BREST (FR); Tangui LE GLEAU, BREST (FR)

(21) Appl. No.: 19/673,378

(22) Filed: May 11, 2026

(30) Foreign Application Priority Data
May 12, 2025 (FR) FR2505014

(51) Int. Cl. G10L 25/51; G06F 3/16; H04R 3/00

(52) U.S. Cl. CPC G10L 25/51; G06F 3/162; H04R 3/005

(57) ABSTRACT

An acoustic monitoring system includes an interface for receiving a plurality of sound samples provided by at least one acoustic sensor located in an area to be monitored, and an analyzer for analyzing sound samples to generate alerts. It further includes a deduplication system designed to group at least some of the received sound samples or the alerts generated by the analyzer based on at least one criterion of sound similarity, so as to create a reduced number of group(s) of sound samples or alerts, and to determine a consolidated sound sample or a consolidated alert for each group created.

### CROSS-REFERENCE TO RELATED APPLICATIONS

This application claims priority to French Patent Application No. 2505014, filed May 12, 2025, the entire content of which is incorporated herein by reference in its entirety.

The present invention relates to an acoustic monitoring system, an acoustic monitoring method implemented by this system, and a computer program comprising instructions for implementing such an acoustic monitoring method when executed by the system.

### BACKGROUND OF THE INVENTION

This type of monitoring system is designed to receive sound samples provided by at least one acoustic sensor located in an area to be monitored, such as a communal living space for vulnerable and/or elderly individuals who require close monitoring and intervention in the event that a problem or anomaly is detected. In this case, multiple acoustic sensors are advantageously distributed throughout various private and common areas of the area to be monitored. Generally, the in-depth analysis of captured sounds for the purpose of detecting an anomaly, triggering an alert, and making a possible decision regarding a potential intervention, is not performed locally but remotely by a monitoring server equipped with substantial computing means, which may be shared among multiple areas under monitoring. Each acoustic sensor is then integrated into a communicating or connected device, for example one compatible with IoT (Internet of Things) technology, whereby the device is equipped locally with a sensor, limited processing capabilities, and means for transmitting data from the sensor to the remote server via a local network or the Internet.

Compared to other possible technologies such as video, wearable devices, or call buttons, acoustic monitoring has the advantage of being less intrusive, as well as being cost-effective and capable of triggering alerts in real time. Video monitoring has the advantage of providing detailed visual information that allows for a more refined analysis of a situation that can sometimes be complex to interpret acoustically, but it has the disadvantage of raising privacy concerns, being costly, and being dependent on lighting conditions and field of vision. Wearable devices have the advantage of providing personalized information that directly responds to the wearer's movements, but they have the disadvantage of being heavily dependent on the wearer's compliance and regular maintenance, which makes them impractical on a large scale. Emergency call buttons, although intuitive and moderately priced, suffer from an inability to detect certain serious emergency situations since they rely on interaction with the people likely to experience these emergencies: for example, it has been observed that approximately 85% of frail and/or elderly people living in communities do not activate them in situations that would otherwise warrant the issuance of alerts, particularly in situations where these people are on the ground following a fall.

Acoustic monitoring thus strikes a balance between practicality and effectiveness. Thanks to acoustic sensors, such as simple microphones, strategically placed in private living quarters and common hallways within a residential facility for vulnerable and/or elderly individuals, it can detect key auditory information, such as calls for help or unusual noises, and alert caregivers in real time.

### DESCRIPTION OF THE PRIOR ART

Increasingly, analysis means include an artificial intelligence software module comprising at least one machine learning engine that takes sound samples as input and outputs a classification-based recognition of those samples, with at least one class designated for generating alerts. In a medical application where monitoring is used to establish a diagnosis, an example of such a system is described in patent document EP 3 762 942 B1. In another application for remote monitoring of care provided to vulnerable individuals, where monitoring is intended to detect potential abuse suffered by these individuals, another example of such a system is described in detail in patent document US 2022/0108704 A1.

However, this acoustic approach is not without its problems, particularly because it is blind. Alerts must be reliable. While false negatives (i.e., the absence of an alert in a situation that calls for one) must be strictly avoided for obvious safety reasons, false positives (i.e., the generation of an alert in a situation that does not call for one) can lead to unnecessary or untimely interventions. The main challenge lies in the ambiguity of the sound source or the sound sample itself, whether spatial or temporal, in certain situations other than those described in the aforementioned documents EP 3 762 942 B1 and US 2022/0108704 A1, for example, in a communal living facility for vulnerable and/or elderly individuals living with relative autonomy, each having their own private living space and sharing common areas with others. In terms of spatial ambiguity, a single sound sample, such as a cry for help, can be repeated as it propagates through space, first within the private space where it originates, but also in a neighboring private space and/or a neighboring common space, potentially triggering multiple alerts and interventions, only one of which is ultimately relevant. In terms of temporal ambiguity, a single sound sample, such as an alarming scream, can be repeated over time, potentially triggering multiple alerts and interventions too, only one of which is relevant. In terms of spatiotemporal ambiguity, a single sound sample, such as a scream, can be repeated over time and space, particularly if it comes from a person moving from one location to another within the monitored area while repeatedly uttering the same scream, which in turn can potentially trigger multiple alerts and interventions, only one of which is relevant.

By way of a non-limiting example in a non-limiting application context, according to a first scenario of spatial ambiguity illustrated in FIG. 1, a first resident 10 present in a first private location 12 within an area to be monitored Z, for example a specialized collective residential facility for the elderly or vulnerable, emits a sound 14, such as a cry for help.

The first private location 12 is equipped with a communicating device 16 that communicates with a remote monitoring server 18. The communicating device 16 itself comprises an acoustic sensor 20, such as a microphone, a local computer 22 coupled to the acoustic sensor 20, and a transceiver 24 coupled to the local computer 22. It is, for example, mounted on the ceiling of the first private location 12. The remote monitoring server 18, for its part, is located outside the area to be monitored Z. It may serve multiple communicating devices located in various private or common locations of the specialized collective residential facility and may be housed in a dedicated monitoring room. In this case, it is advantageously connected to the various communicating devices in the residential facility via a local telecommunications and/or data transmission network. It may also be shared by multiple communicating devices located in various private or common locations across multiple residential facilities. In this case, it is connected to the various communicating devices via a wide-area telecommunications and/or data transmission network such as the Internet 26. In all cases, it is equipped with means to trigger an alarm or alert a response team 28 when an anomaly is detected.

The area to be monitored Z includes a second private location 30, which is also equipped with a second communicating device 32 similar to communicating device 16, and in which a second resident 34 is present. This second private location 30 is adjacent to the first private location 12. The area to be monitored Z also includes a third common location 36, such as a hallway serving the private locations 12 and 30, which is also equipped with a third communicating device 38 similar to the communicating devices 16 and 32. The area to be monitored Z may, of course, include many other private or common locations equipped with communicating devices such as communicating devices 16, 32, and 38, since it can extend to the entire specialized collective residential facility, as indicated above.

In the first scenario, the cry for help sound 14 emitted by the first resident 10 is detected by the acoustic sensor 20 of the first communicating device 16. The latter then transmits a first sound sample S1 to the remote monitoring server 18. However, this sound 14 travels through the walls and is also detected, albeit in a lower volume, by the acoustic sensor of the second communicating device 32 located in the adjacent second private location 30. The second communicating device 32 then transmits a second sound sample S2 to the remote monitoring server 18. The same sound 14 is also detected, albeit at a lower volume, by the acoustic sensor of the third communicating device 38 located in the adjacent hallway 36. The third communicating device 38 then transmits a third sound sample S3 to the remote monitoring server 18.

Assuming that the first sound sample S1, as analyzed by the remote monitoring server 18, triggers an alert, there is no reason why sound samples S2 and S3, which exhibit the same characteristics, albeit in a lower volume, should not also trigger alerts. Three redundant but independent alerts A1, A2, A3 are then generated based on a single sound event. As is known per se, these three independent alerts can trigger independent responses from three different members of the response team 28, with one heading toward the first private location 12, and the other two heading toward the second and third private and common locations 30, 36, respectively. Of course, only the first alert A1 is justified, the other two A2 and A3 being false positives. This therefore leads to some confusion and inefficiency. Furthermore, if the first resident 10 is known by the response team 28 to call for help inappropriately when in their private location 12, then the responder called to go to the first private location 12 may ultimately decide not to go. However, the other two will not be able to make such a decision, given the different origins of the sound samples associated with alerts A2 and A3.

As a non-limiting example too, in a second scenario of temporal ambiguity illustrated in FIG. 2, the first resident 10 present in the first private location 12 of the area to be monitored Z emits the sound 14, but this time in the form of a series of taps on the floor using his cane.

According to this second scenario, the sound 14 of taps on the floor emitted by the first resident 10 at time T1 is detected by the acoustic sensor 20 of the first communicating device 16. The latter then transmits a first sound sample S1 to the remote monitoring server 18. However, the sound 14, i.e., the same series of taps on the floor or a very similar series of taps, is repeated by the first resident 10 at time T2 while he is still present in the first private location 12. It is again detected by the acoustic sensor 20 of the first communicating device 16. The latter then transmits a second sound sample S2 to the remote monitoring server 18. This sound 14, i.e., the same series of taps on the floor or a very similar series of taps, is repeated again by the first resident 10 at time T3 while he is still present in the first private location 12. It is again detected by the acoustic sensor 20 of the first communicating device 16. The latter then transmits a third sound sample S3 to the remote monitoring server 18.

Assuming that the first sound sample S1, as analyzed by the remote monitoring server 18, triggers an alert, there is no reason why the subsequent sound samples S2 and S3, which have the same characteristics, or very similar characteristics, should not also trigger alerts. Three redundant but independent alerts A1, A2, and A3 are then generated based on a single repeated sound event. As is well known, these three independent alerts can trigger independent responses from three different members of the response team 28, all three of whom are successively called upon at times T1, T2, and T3 to proceed to the first private location 12. Of course, only the first alert A1 is justified; the other two, A2 and A3, are false positives. This therefore once again leads to some confusion and inefficiency.

As a non-limiting example too, in a third scenario of spatiotemporal ambiguity illustrated in FIG. 3, the first resident 10 present in the first private location 12 of the area to be monitored Z emits the sound 14, but this time in the form of an alarming cry.

According to this third scenario, the alarming cry sound 14 emitted by the first resident 10 at time T1 is detected by the acoustic sensor 20 of the first communicating device 16. The latter then transmits a first sound sample S1 to the remote monitoring server 18. However, this sound 14 travels through the walls and is also detected, albeit at a lower volume, by the acoustic sensor of the second communicating device 32 located in the adjacent second private location 30. The second communicating device 32 then transmits a second sound sample S2 to the remote monitoring server 18. The same sound 14 is also detected at a lower volume by the acoustic sensor of the third communicating device 38 located in the adjacent hallway 36. The third communicating device 38 then transmits a third sound sample S3 to the remote monitoring server 18.

Still according to this third scenario, sound 14, i.e., the same alarming cry or a very similar one, is repeated by the first resident 10 at time T2, just as he has left the first private location 12 and is in the hallway 36. It is detected by the acoustic sensor of the third communicating device 38. The latter then transmits a fourth sound sample S4 to the remote monitoring server 18. However, this sound 14 travels through the walls and is also detected, albeit at a lower volume, by the acoustic sensor 20 of the first communicating device 16 located in the first private location 12. The first communicating device 16 then transmits a fifth sound sample S5 to the remote monitoring server 18. The same sound 14 is also detected at a lower volume by the acoustic sensor of the second communicating device 32 located in the second private location 30. The second communicating device 32 then transmits a sixth sound sample S6 to the remote monitoring server 18.

Still according to this third scenario, sound 14, i.e., the same alarming cry or a very similar one, is repeated by the first resident 10 at time T3 while he has moved into hallway 36 and is near the second private location 30. It is detected by the acoustic sensor of the third communicating device 38. The latter then transmits a seventh sound sample S7 to the remote monitoring server 18. However, this sound 14 travels through the walls and is also detected, albeit at a lower volume, by the acoustic sensor of the second communicating device 32 located in the second private location 30. The second communicating device 32 then transmits an eighth sound sample S8 to the remote monitoring server 18. The same sound 14 is also detected at a lower volume by the acoustic sensor 20 of the first communicating object 16 located in the first private location 12. The first communicating device 16 then transmits a ninth sound sample S9 to the remote monitoring server 18.

Assuming that the first sound sample S1, as analyzed by the remote monitoring server 18, triggers an alert, there is no reason why the subsequent sound samples S2 to S9, which have the same characteristics or very similar characteristics, should not also trigger alerts. Nine redundant but independent alerts A1, A2, A3, A4, A5, A6, A7, A8, A9 are then generated based on a single repeated sound event. As known per se, these nine independent alerts can trigger independent responses from up to nine different members of the response team 28, all of whom are successively called upon at times T1, T2 and T3 to proceed to the first private location 12, the second private location 30, and the common hallway 36. Of course, only the first alert A1 is justified, the other eight A2 to A9 being false positives. This therefore once again leads to some confusion and inefficiency.

Various solutions have been explored to address this type of acoustic ambiguity. However, they are generally complex, as exemplified by the solution described in the article by Chakraborty et al., entitled “Joint model-based recognition and localization of overlapped acoustic events using a set of distributed small microphone arrays”, published in arXiv. org under reference arXiv: 1712.07065 on Dec. 19, 2017. The latter requires the installation of distributed networks of small microphones to locate and identify multiple captured sound samples, as well as a complex joint analysis model. It is further effective for identifying and locating a sound within a single room, such as a meeting room, but not for resolving sound ambiguities spread across more complex areas under monitoring.

It may therefore be desirable to provide an acoustic monitoring system that makes it possible to get rid of at least some of the aforementioned problems and constraints.

### SUMMARY

An aspect of the invention therefore relates more specifically to an acoustic monitoring system, comprising:
an interface for receiving a plurality of sound samples provided by at least one acoustic sensor located in an area to be monitored; and
an analyzer configured to analyze sound samples to generate alerts.

An acoustic monitoring system is therefore proposed comprising:
an interface for receiving a plurality of sound samples provided by at least one acoustic sensor located in an area to be monitored;
an analyzer configured to analyze sound samples to generate alerts; and
a deduplication system configured to group together at least some of the sound samples received or alerts generated by the analyzer based on at least one criterion of sound similarity, so as to create a reduced number of group(s) of sound samples or alerts, and to determine a consolidated sound sample or a consolidated alert for each group created.

Thus, by performing simple groupings based on sound similarity, where such groupings may involve one or more acoustic sensors, and by determining a consolidated sound sample (to be analyzed to potentially trigger an alert) or a consolidated alert for each group created, it is possible to reduce, or even eliminate, the aforementioned spatial, temporal, or spatiotemporal ambiguities. The false positives previously mentioned are thus effectively avoided thanks to simple means that eliminate the need for multiple acoustic sensors, specifically, the installation of sensor/microphone networks, as taught in the article by Chakraborty et al., in every private or common location within the area to be monitored.

Optionally, an acoustic monitoring system according to an aspect of the invention may further comprise:
said at least one acoustic sensor located in the area to be monitored; and/or
an interface for automatically transmitting each alert generated from a consolidated sound sample or each consolidated alert to a pre-registered terminal belonging to a user authorized to intervene.

Also optionally, the deduplication system is designed to:
group together multiple sound samples or multiple alerts from multiple acoustic sensors respectively located in multiple distinct locations within the area to be monitored, into a single group of sound samples or alerts, when said sound samples or alerts further fall within the same predetermined first time window, for example a first time window of 10 to 20 seconds; and
determine the consolidated sound sample or consolidated alert by selecting, from each created group, the sound sample or alert with the highest sound level, classification confidence score, or signal-to-noise ratio.

Also optionally, the deduplication system is designed so as, when multiple sound samples or multiple alerts originating from a single acoustic sensor among said at least one acoustic sensor are grouped together into a single group created within a second predetermined time window, for example a second time window of at least one hour, to exclude from the determination of the consolidated sound sample or consolidated alert of that group any sound sample or alert other than the one emitted first from said single acoustic sensor.

Also optionally, the at least one criterion of sound similarity applied by the deduplication system comprises at least one element from the set consisting of:
spectral proximity between sound samples in terms of spectral envelopes;
spectral proximity between sound samples in terms of characteristic frequencies;
spectral proximity between sound samples in terms of frequency amplitudes;
temporal proximity between sound samples in terms of temporal envelopes;
temporal proximity between sound samples in terms of temporal amplitudes; and
temporal proximity between sound samples in terms of duration.

Also optionally, an acoustic monitoring system according to an aspect of the invention may include additional systems for suppressing at least one alert derived from a consolidated sound sample or at least one consolidated alert, such suppression resulting from the application of predetermined rules and/or machine learning.

Also optionally, the deduplication system is more specifically designed to: group at least some of the received sound samples based on said at least one criterion of sound similarity, so as to create a number of group(s) of sound samples that is less than the number of received sound samples; determine a consolidated sound sample for each group created; and supply each consolidated sound sample to the analyzer rather than each received sound sample.

Also optionally, the acoustic monitoring system is designed to supply all received sound samples to the analyzer, and the deduplication system is more specifically designed to:
group at least some of the alerts generated by the analyzer based on said at least one criterion of sound similarity, this criterion of sound similarity relating to the analyzed sound samples that generate the alerts, so as to create a reduced number of alert group(s);
determine a consolidated alert for each group created.

Also optionally, the acoustic monitoring system is designed for N acoustic sensors located in the area to be monitored and includes a device for storing in memory an acoustic proximity matrix AP, in which each matrix coefficient AP_{m,n}, where 1≤m≤N and 1≤n≤N, comprises at least one probability value that at least one predetermined sound emitted in the vicinity of the acoustic sensor Cm and mainly detected by it is also detected by the acoustic sensor Cn, the deduplication system being designed to use this acoustic proximity matrix AP to exclude from sound similarity computations certain pairs of acoustic sensors deemed too far from one another based on the corresponding matrix coefficient.

An acoustic monitoring method is also proposed, comprising the following steps:
receiving a plurality of sound samples provided by at least one acoustic sensor located in an area to be monitored;
generating, by an analyzer for analyzing sound samples of an acoustic monitoring system, alerts resulting from at least some of the sound samples that they receive;
grouping, by a deduplication system of the acoustic monitoring system, of at least some of the received sound samples or alerts generated by the analyzer based on at least one criterion of sound similarity, so as to create a reduced number of group(s) of sound samples or alerts;
determination, by the deduplication system, of a consolidated sound sample or a consolidated alert for each group created.

A computer program is also proposed, which can be downloaded from a communication network and/or stored on a non-transitory computer-readable medium and/or executed by a processor, comprising instructions for performing the steps of an acoustic monitoring method according to the invention, when said program is executed by at least one computer of an acoustic monitoring system according to the invention.

### BRIEF DESCRIPTION OF THE DRAWINGS

The invention will be better understood thanks to the following description, which is provided solely by way of example and with reference to the accompanying drawings, wherein:

FIG. 1, already described, illustrates a first scenario that generates redundant alerts;

FIG. 2, already described, illustrates a second scenario that generates redundant alerts;

FIG. 3, already described, illustrates a third scenario that generates redundant alerts;

FIG. 4 diagrammatically represents the general structure of an installation with an acoustic monitoring system according to a first embodiment of the invention;

FIG. 5 diagrammatically represents the general structure of an installation with an acoustic monitoring system according to a second embodiment of the invention;

FIG. 6 illustrates the successive steps of an acoustic monitoring method implemented by the system shown in FIG. 4; and

FIG. 7 illustrates the successive steps of an acoustic monitoring method implemented by the system shown in FIG. 5.

### DESCRIPTION OF THE PREFERRED EMBODIMENTS

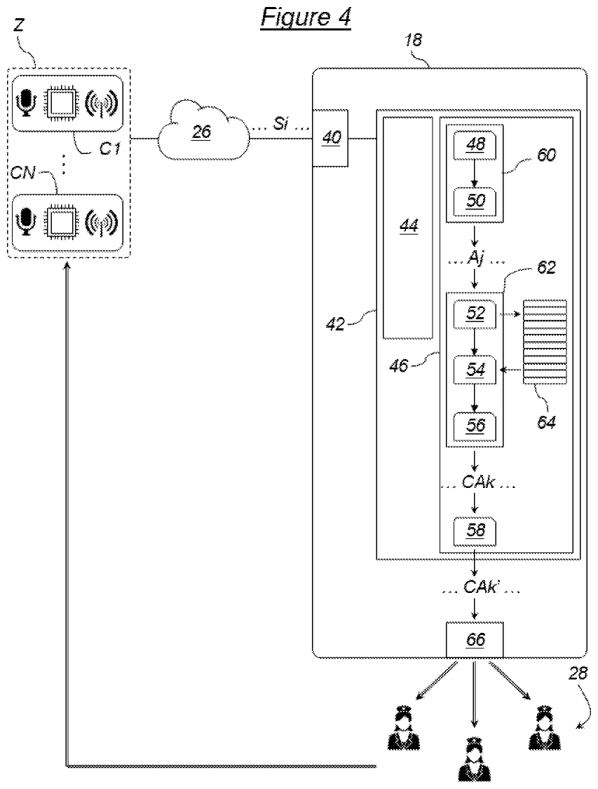

The installation shown schematically in FIG. 4 illustrates, in simplified form, the area to be monitored Z and the plurality of communicating devices equipped with acoustic sensors, generically denoted C1, . . . , CN, that it comprises and which are distributed throughout the common and private spaces. In accordance with the general principles of the present invention, a single acoustic sensor, for example a single microphone, may be provided in each common or private space within the area to be monitored Z. Thus, a single communicating device may beneficially be provided per common or private space. However, as an alternative, the general principles of the present invention also do not preclude the arrangement of multiple acoustic sensors and communicating devices within the same common or private space of the area to be monitored Z, particularly when that space is large or consists of multiple rooms. Each acoustic sensor, such as sensor 20, of each communicating device C1, . . . , CN provides a signal carrying acoustic information. This signal is optimal in terms of content, since it is provided directly by the acoustic sensor without any specific post-processing. Its quality therefore depends solely on the acoustic sensor itself. It is provided at every instant t, according to a predetermined optimal temporal sampling rate or continuously if possible. Each local computer, such as computer 22, of each communicating device C1, . . . , CN is beneficially designed to consume little energy, particularly in accordance with IoT technology. It therefore has limited computing power and memory compared to that of the remote monitoring server 18. Apart from that, it may feature a completely conventional architecture consisting of a processing unit (e.g., a processor) coupled with at least one memory (e.g., RAM or another type of memory) for storing data files and computer programs the instructions of which are intended to be executed by the processing unit. Each local computer of each communicating device C1, . . . , CN thus functionally comprises several computer programs or several functions of a single computer program to process the signal provided by the corresponding acoustic sensor and to output, as a result of this processing, successive, time-limited sound samples that may contain relevant information to be analyzed by the monitoring server 18. It should be noted that a compromise must be found regarding the processing to be performed by each local computer, between the most efficient processing possible, which reduces the transmission load of the sound samples but requires a minimum of local computing capacity, and the simplest processing possible, which reduces the required local computing capacity but places a greater demand on the transmission capacity of the network 26. Furthermore, it is entirely feasible to implement a feedback loop between each communicating device C1, . . . , CN and the remote monitoring server 18 to configure this local processing according to the server's analysis requirements, which may change over time and according to the situation.

The installation shown in FIG. 4 further illustrates in greater detail the remote monitoring server 18, capable of interacting with the communicating devices C1, . . . , CN via the aforementioned network 26. To this end, it includes an interface 40 for receiving a plurality of sound samples Si provided by the acoustic sensors of the communicating devices C1, . . . , CN after processing by the local computers.

It further comprises a remote computer 42, beneficially equipped with computing power and memory capacity significantly greater than that of each local computer. Apart from that, the remote computer 42 may have a completely conventional architecture comprising a processing unit 44 (e.g., a processor) coupled to at least one memory 46 (e.g., RAM or another type of memory). For example, it can be implemented in a computer system such as a conventional computer comprising a processor coupled to one or more memory units for storing data files and computer programs the instructions of which are intended to be executed by the processing unit 44. As shown in FIG. 4, the remote computer 42 thus functionally comprises six computer programs 48, 50, 52, 54, 56, 58 or six functions of a single computer program divided into several functional software modules. It should be noted that the computer programs 48, 50, 52, 54, 56, 58 are presented as distinct, but this distinction is purely functional. They could just as easily be grouped in any of the possible combinations into one or more software packages. Their functions could also be, at least in part, microprogrammed or microwired into dedicated integrated circuits. Thus, as an alternative, the computing device implementing the remote computer 42 could be replaced by an electronic device consisting solely of digital circuits (without a computer program) to perform the same functions. Alternatively, at least some of the aforementioned computer programs could be remote and accessible by the remote computer 42 via the Internet. Generally speaking, even though all of the aforementioned software and memory components are shown as being housed within the same remote computer 42, they could just as easily be distributed across separate hardware components, even located far apart from one another, but interconnected via a network (data transmission bus, local area network, wide area network, the Internet, etc.).

The computer programs 48 and 50 are included in a first software functional module 60 that serves as a system for analyzing sound samples to generate alerts. The analyzer is implemented as a software functional module executing on the processing unit 44 of the remote computer 42, which comprises a processing unit 44 coupled to at least one memory 46, the memory 46 storing instructions that, when executed by the processing unit 44, cause the processing unit 44 to perform all of the analysis functions described herein, including receiving sound samples as input, classifying said sound samples, and generating alerts based on said classification. This first analysis functional module 60 is, for example, an artificial intelligence software module with at least one machine learning engine that receives the sound samples as input to provide, as output, recognition of these samples through classification, with at least one class designated for generating alerts. In this regard, it could be designed in accordance with the teachings of the aforementioned documents EP 3 762 942 B1 and US 2022/0108704 A1. It could also incorporate an expert system based on rules and an inference engine. In terms of artificial intelligence, it could also combine the strengths of at least one machine learning engine and an expert system. The processing unit 44, operating in conjunction with the memory 46 and the instructions stored therein, constitutes sufficient structure to perform all of the analysis functions attributed to the analyzer throughout this disclosure.

Optionally but ingeniously, and by way of a non-limiting example, the first analysis functional module 60 shown in FIG. 4 actually comprises:
the computer program 48 comprising instructions which, when executed by the processing unit 44, implement at least a first supervised machine learning engine for sound detection, said first engine being capable of detecting one or more sound classes, such as “cry for help,” “scream,” “moan,” “fall,” “vomiting,” etc., from the provided sound samples; and
the computer program 50 comprising instructions which, when executed by the processing unit 44, implement at least a second supervised machine learning engine for state detection, this second engine being capable of detecting one or more classes of states based on the class or classes of sounds detected by the first engine, each state class representing an environmental state (i.e., any location or person) within the area to be monitored Z, at least one of these state classes representing an alert.

This two-tiered arrangement of supervised machine learning engines is not the subject matter of the present invention, although it can beneficially be combined with its general principles; therefore, it will not be described in further detail.

In accordance with the general principles of an aspect of the present invention, the computer programs 52, 54, and 56 are included in a second software functional module 62 forming a deduplication system configured to perform all of the deduplication functions described herein. The deduplication system is implemented as a software functional module executing on the processing unit 44 of the remote computer 42, which comprises the processing unit 44 coupled to at least one memory 46, the memory 46 storing instructions embodied in computer programs 52, 54, and 56 that, when executed by the processing unit 44, cause the processing unit 44 to perform all of the deduplication functions attributed to the deduplication system throughout this disclosure including:
grouping together at least some of the received sound samples Si or alerts generated by the first analysis functional module 60 based on at least one criterion of sound similarity, so as to create a reduced number of group(s) of sound samples or alerts; and
determining a consolidated sound sample or a consolidated alert for each group created.

The processing unit 44, operating in conjunction with the memory 46 and the instructions of computer programs 52, 54, and 56 stored therein, constitutes sufficient structure to perform all of the deduplication functions attributed to the deduplication system throughout this disclosure. Specifically, computer program 52 provides the structure for accumulating sound samples or alerts within predetermined time windows; computer program 54 provides the structure for computing sound similarity and grouping sound samples or alerts based on at least one criterion of sound similarity; and computer program 56 provides the structure for determining a consolidated sound sample or consolidated alert for each group created.

More specifically, in the first embodiment illustrated in FIG. 4, the first analysis functional module 60 is programmed to analyze all sound samples Si received by the interface 40 and, when applicable, generate alerts Aj, with the number of alerts generated being less than or equal to the number of sound samples.

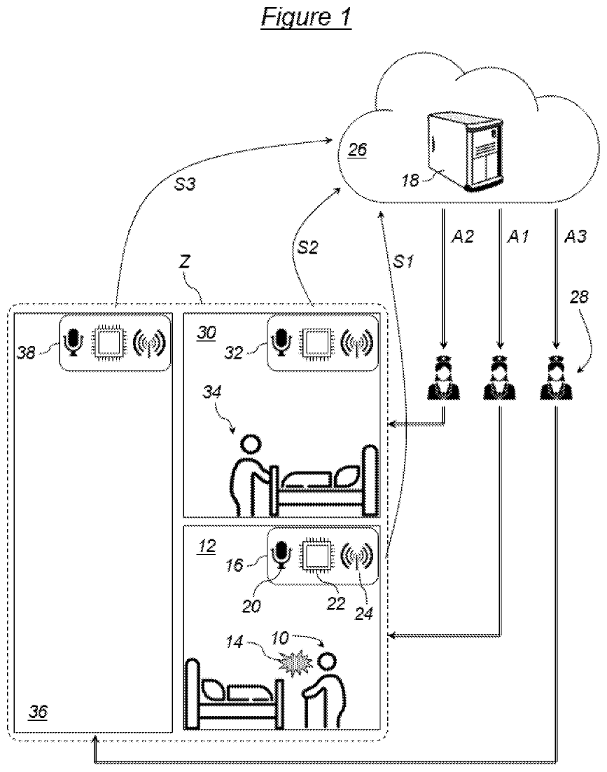

These alerts Aj, which may be redundant given the possible scenarios shown in FIGS. 1 to 3, are provided to the second software-based deduplication functional module 62.

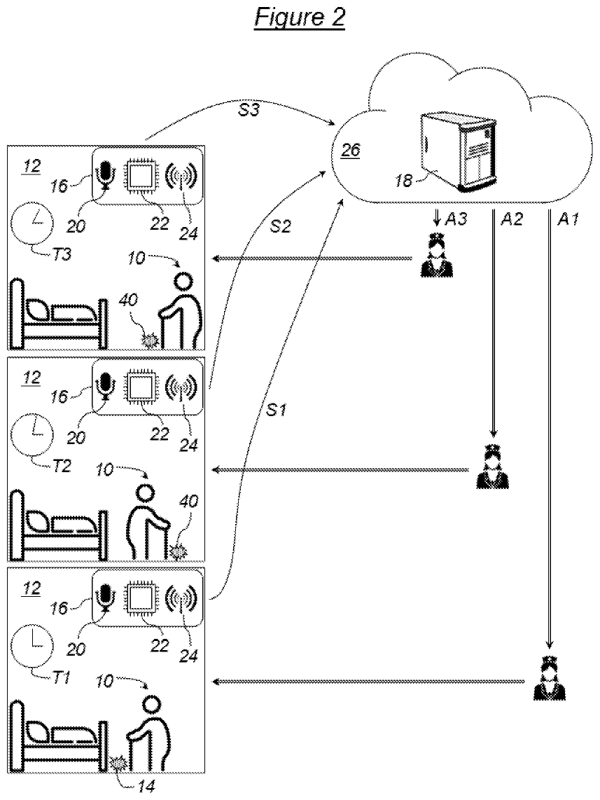

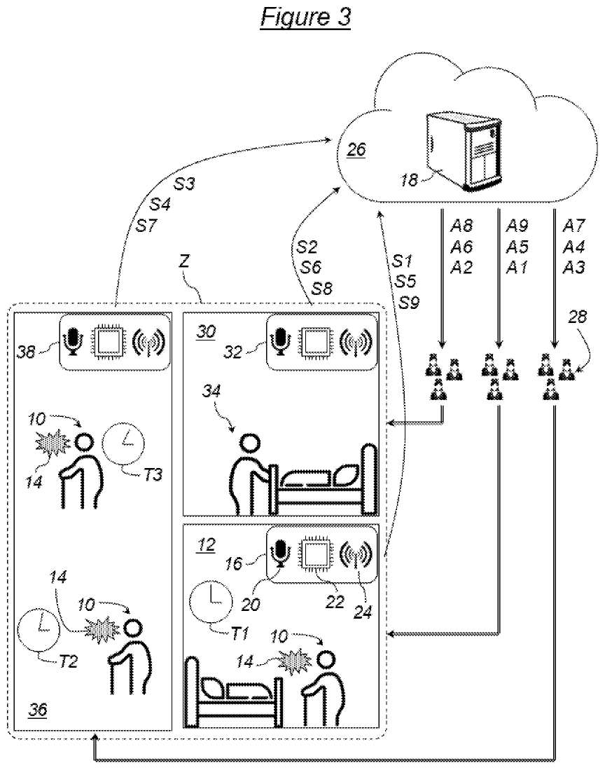

The computer program 52 of the second software-based deduplication functional module 62 includes instructions which, when executed by the processing unit 44, accumulate, in at least one buffer 64, alerts Aj received within at least one predetermined time window:
for example, within a single predetermined first time window of 10 to 20 seconds when it is desired to reduce or eliminate spatial redundancies, this short first time window allowing for variations in network 26 latency as well as variations in time-stamping (i.e., start, duration, and/or end) of sound samples from the same sound 14 but detected by different acoustic sensors respectively located in several distinct locations within the area to be monitored Z: see the scenario the FIG. 1;
for example, within a single predetermined second time window of at least one hour when it is desired to reduce or eliminate temporal redundancies, this longer second time window allowing for taking into account possible repetitions over time of the same sound captured by a single acoustic sensor: see the scenario in FIG. 2;
for example, within several distinct time windows, including the first and second time windows mentioned above, when it is desirable to reduce or eliminate spatial, temporal, and spatiotemporal redundancies: see the scenario in FIG. 3.

The computer program 54 of the second software-based deduplication functional module 62 includes instructions which, when executed by the processing unit 44, group together at least some of the alerts Aj accumulated by the execution of the computer program 52 based on at least one criterion of sound similarity, so as to create a reduced number of alert group(s). This criterion of sound similarity applies to the analyzed sound samples that generated the accumulated alerts, respectively. For example, it may take the form of at least one of the following criteria:
a spectral proximity between sound samples in terms of spectral envelopes;
a spectral proximity between sound samples in terms of characteristic frequencies;
a spectral proximity between sound samples in terms of frequency amplitudes;
a temporal proximity between sound samples in terms of temporal envelopes;
a temporal proximity between sound samples in terms of temporal amplitudes; and
a temporal proximity between sound samples in terms of duration.

It is applied, for example, using a predetermined similarity threshold value above which compared alerts are considered to originate from the same sound event. The similarity computation itself can be performed using known methods such as machine learning methods, e.g., nearest neighbors, advanced feature extraction techniques, the cosine similarity method, cross-correlation computation, adaptive filtering, etc.

Optionally, a training process may be conducted beforehand using predetermined sounds classified as “opportunistic”, for example sounds with high amplitudes or spectral content presumed to propagate easily, to estimate a priori the acoustic proximity of the respective acoustic sensors of the communicating devices C1, . . . , CN. The result of this learning process can be stored in memory 46 in the form of a square acoustic proximity matrix denoted AP, where each coefficient AP_{m,n}, where 1≤m≤N and 1≤n≤N, comprises at least one probability value that at least one opportunistic sound emitted near the acoustic sensor of the communicating device Cm and primarily detected by it is also detected by the acoustic sensor of the communicating device Cn. By using this matrix AP, computer program 54 is able to exclude from similarity computations certain pairs of communicating devices that are deemed too far apart based on the corresponding matrix coefficient, so that alerts generated by these pairs are not grouped together even when the corresponding acoustic samples are similar and temporally close. This simplifies similarity calculations. It also helps avoid certain false negatives when two distinct but acoustically similar sound events occur simultaneously: for example, two bottles falling to the floor and breaking at the same time in two private spaces that are acoustically distant in the area to be monitored Z.

Finally, the computer program 56 of the second software-based deduplication functional module 62 includes instructions which, when executed by the processing unit 44, determine a consolidated alert for each group formed by the execution of the computer program 54. This determination is made, for example, by selecting one of the alerts from each group, specifically the one considered most relevant within its group because it originates from the sound sample having the highest sound level (i.e., maximum volume), or the highest classification rate, or the highest signal-to-noise ratio. This selection is particularly useful for resolving spatial ambiguities based on the first time window defined earlier. In addition to or independently of this, this determination can also be made, for example, by excluding from each group any alert other than the first one issued by a single acoustic sensor. This additional support for selection is particularly useful for resolving temporal ambiguities based on the second time window defined earlier, specifically to apply a short-duration mute (i.e., the duration of the second time window) to the relevant acoustic sensor after receiving a first alert. It is further conceivable to make the duration of this second time window variable depending on the type of alert and to make several similar types of alerts (for example, a “distress call” alert and a “scream” alert) dependent on the same observation time window.

As a result of the execution of computer program 56, the second software-based deduplication functional module 62 generates consolidated alerts CAk, which are a priori fewer in number than the alerts Aj it received, and, more importantly, are much less redundant or even entirely non-redundant.

It will be appreciated that if only a single alert accumulates in buffer 64, the grouping and selection performed by the execution of computer programs 54, 56 are reduced to their simplest form, that is, the output of that alert as-is as a consolidated alert. Similarly, if multiple alerts accumulate in buffer 64 but none are deemed similar to another, the grouping and selection performed by the execution of computer programs 54, 56 output these alerts as-is as consolidated alerts.

Optionally but beneficially, it may be desirable to extend the scope of the aforementioned mute in terms of time and functionality. Thus, the computer program 58 includes instructions which, when executed by the processing unit 44, are capable of suppressing at least one consolidated alert by applying predetermined rules and/or machine learning.

By way of example, but not limited to this, it may be desirable to disregard certain consolidated alerts in very specific situations that can be defined using rules of the form “if <conditions> then <rule 1> else <rule 2>”. Specifically, consolidated alerts that recur over several days, or even over the course of one or more hours, can be muted for several subsequent days or hours, meaning no intervention is triggered, when a resident in the area to be monitored Z reaches a certain number of alert triggers of a specific type within a predefined time period. Variable threshold values can be applied depending on the type of alert. For example: “If there are more than 7 ‘cry’ alerts per day from the same person over 4 consecutive days, then any ‘cry’ alerts from that person will be muted starting on the 5th day for a predetermined period of time.”.

More generally, a rule-based model can be used to represent recurring situations and select the alert that best represents a given event during which multiple alerts will have been generated.

For example, starting from a normal situation with no alerts, the generation of successive alerts can increase a measure of a situation's severity, which is then used to determine how to handle them, in accordance with:
an first build-up phase during which sound samples are aggregated to determine whether a current event deserves being converted into an alert: this phase is particularly useful for aggregating weak signals that, taken individually, might have been ignored; it also allows for the handling of alerts that generate false positives (that is, to be ignored) but the rapid repetition of which is a sign of an ongoing event that deserves some attention (for example, breathing difficulties or the sound of a machine); alerts can be grouped by type (that is, crying, moaning, or vocal calls), thereby collectively contributing to a single severity metric;
reaching a sufficient severity measurement value, which then involves the designation of one of the received alerts as the representative of the event and its transmission; otherwise, the entire sequence of alerts is muted;
a muting period of a duration that cannot be reduced following the transmission of the designated representative alert, this muting depending on the types of subsequent alerts, with only related type alerts being muted and others not (for example, the detection of a fall to be transmitted following several successive cries, of which only the first is transmitted as an alert);
taking into account the proximity in time of alerts and their types to determine whether they are part of the same event or not, when the event is ongoing.

By way of a non-limiting example too, the muting function may be adaptive and scalable by using a machine learning engine, so as to automatically adjust to the habits of each resident in the area to be monitored Z. In other words, if a sound is recognized as routine for a resident, such as a frequent cough or a repetitive noise, the machine learning engine identifies it, using a training model formed on labeled data, as non-critical and suppresses the consolidated alert triggered by that routine sound. The system continuously learns and adapts to familiar sounds, thereby minimizing irrelevant consolidated alerts over time. This type of muting is particularly well-suited to longer time scales, such as weekly or monthly intervals, which a rule-based system struggles to handle.

After executing the computer program 58, the remote computer 42 provides consolidated and confirmed alerts CAk′, which can then be transmitted to an automatic transmission interface 66 of the remote monitoring server 18, for sending each of these consolidated and confirmed alerts CAk′ to a pre-registered terminal of a user capable of responding, for example, a member of the response team 28, and to trigger an alarm (audible, visual, via messaging, etc.) or a response.

It should be noted that the aforementioned processing operations, performed by the analysis functional module 60, the deduplication functional module 62, and the muting computer program 58, can be carried out in parallel using a distributed approach capable of reducing computational complexity. Specifically, each alert is recorded in a database of recent alerts and compared with other alerts from the same time window and the same area to be monitored. This enables deduplication without centralizing the processing, thereby improving the system's scalability.

It should also be noted that consolidated and confirmed alerts CAk′ can be transmitted to the automatic transmission interface 66 and then to the terminals of the response team members 28, along with contextual information regarding, in particular, any other alerts from their respective created groups. For example, in the scenario shown in FIG. 1, only alert A1 can be forwarded to a member of the response team 28 after consolidation and confirmation, along with contextual information regarding alerts A2 and A3 (“the distress call was also heard in the private location 30 and in the hallway 36”). In the scenario shown in FIG. 2, only alert A1 can be forwarded to a member of response team 28 after consolidation and confirmation, along with contextual information regarding alerts A2 and A3 (“repeated series of taps to the floor at times T2 and T3, heard in the same private location 12”). In the scenario shown in FIG. 3, only alert A1 can be transmitted to a member of response team 28 after consolidation and confirmation, along with contextual information regarding alerts A2 to A9 (“worrying cry repeated at times T2 and T3, heard in the same private location 12 but also in private location 30 and in the hallway 36”).

It should also be noted that, alternatively, all Alerts Aj could be transmitted to the automatic transmission interface 66 and then to the terminals of the response team 28 members, but with a note for those that are not consolidated and confirmed indicating that a corresponding consolidated and confirmed alert is or has also been transmitted to a response team 28 member. Thus, each response team member notified of such an unconsolidated and unconfirmed alert is informed of the redundancy of the alerts even if no specific action is required on their part. For example, in the scenarios shown in FIGS. 1 and 2, the three alerts A1, A2, A3 can be sent to three different members of the response team 28, only alert A1 requiring action by the recipient, while the other two are sent solely for redundancy purposes. In the scenario shown in FIG. 3, the nine alerts A1 to A9 can be transmitted to nine different members of the response team 28, with only alert A1 requiring action by the recipient, while the other eight are transmitted solely for redundancy purposes.

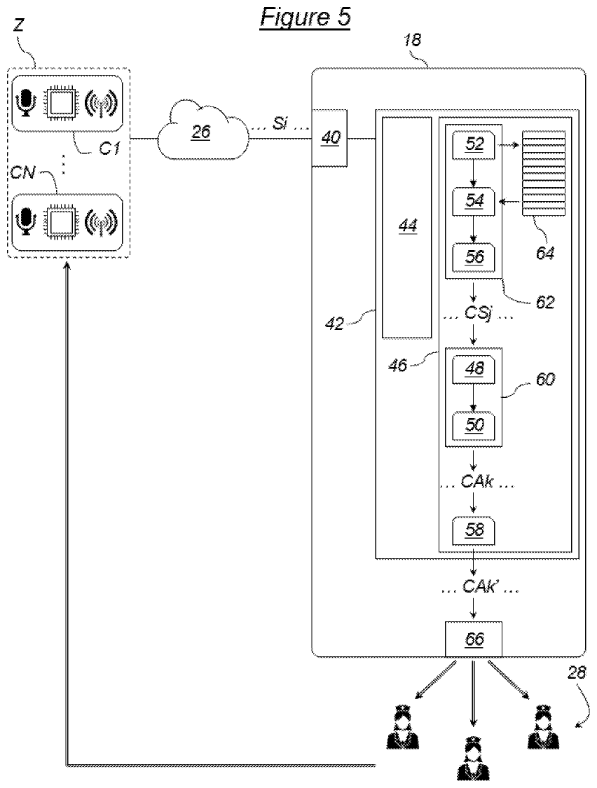

In a second embodiment illustrated in FIG. 5, the remote monitoring server 18 is configured slightly differently, such that the sequence of operations performed by executing computer programs 52, 54, and 56 occurs before the sequence of operations performed by executing computer programs 48 and 50.

As a result, according to this second embodiment, all sound samples Si received by the interface 40 are processed by the second software deduplication functional module 62. Thus, through execution of the computer program 52, they are accumulated in the buffer 64 within one or more of the predetermined time windows mentioned above. Then, through the execution of the computer programs 54 and 56, consolidated sound samples CSj are provided by the second software-based deduplication module 62, a priori fewer in number than the sound samples Si it received, and, more importantly, much less redundant, or even not redundant at all.

It will be appreciated that if only a single sound sample is stored in buffer 64, the grouping and selection performed by the execution of computer programs 54 and 56 are reduced to their simplest form, that is, the reproduction of that sound sample as is, as the consolidated sound sample. Similarly, if several sound samples accumulate in buffer 64 but none are deemed similar to another, the grouping and selection performed by the execution of computer programs 54, 56 reproduce these sound samples as they are as consolidated sound samples.

The consolidated sound samples CSj are then processed by the first analysis functional module 60 to generate, if applicable, consolidated alerts CAk, with the number of consolidated alerts generated being less than or equal to the number of consolidated sound samples.

As in the first embodiment of FIG. 4, the computer program 58 may optionally but advantageously be executed to mute at least one consolidated alert. After execution of the computer program 58, the remote computer 42 provides the consolidated and confirmed alerts CAk′, which can then be transmitted to the automatic transmission interface 66 of the remote monitoring server 18.

It should be noted that the second embodiment effectively reduces the processing load on the first analysis functional module 60 by potentially significantly reducing the number of sound samples provided as input.

It should also be noted that, alternatively, all consolidation alerts CAk could be transmitted to the automatic transmission interface 66 and then to the terminals of the response team 28 members, but with a note indicating, for those that are not confirmed, that a corresponding consolidated and confirmed alert is or has also been transmitted to a response team 28 member.

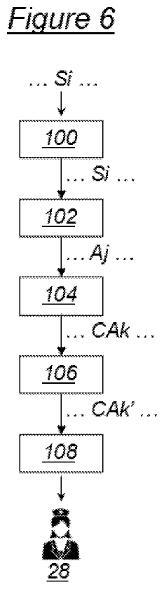

The operation of the remote monitoring server 18 shown in FIG. 4 will now be described in detail with reference to FIG. 6.

During a first reception step 100, which is performed at every instant t, that is, continuously, the interface 40 of the remote monitoring server 18 receives all sound samples Si provided by the acoustic sensors of the communicating devices C1, . . . , CN after processing by the local computers.

During an analysis step 102 performed continuously and in parallel with step 100, the first analysis functional module 60 processes the sound samples Si to generate the alerts Aj by executing the computer programs 48 and 50.

During a subsequent deduplication step 104, the second deduplication functional module 62 processes the alerts Aj to generate the consolidated alerts CAk by successively executing the computer programs 52, 54, and 56. This deduplication 104 involves grouping at least some of the alerts Aj generated in step 102 based on at least one of the aforementioned criteria of sound similarity, so as to create a reduced number of alert group(s), and then determining a consolidated alert for each created group.

In a subsequent optional muting step 106, the consolidated alerts CAk are processed by executing the computer program 58 to generate the consolidated and confirmed alerts CAk′.

Finally, during a transmission step 108, the consolidated and confirmed alerts CAk′ are transmitted to the automatic transmission interface 66 of the remote monitoring server 18, so that each of these consolidated and confirmed alerts CAk′ can be sent to a pre-registered terminal of a user capable of responding, for example, a member of the response team 28, and to trigger an alarm (audible, visual, via messaging, etc.) or a response. As noted earlier, alternatively, all alerts Aj can be sent, wherein those that have not been consolidated and confirmed can be flagged as corresponding to a consolidated and confirmed alert that has been reported and may even already be being handled by another team member.

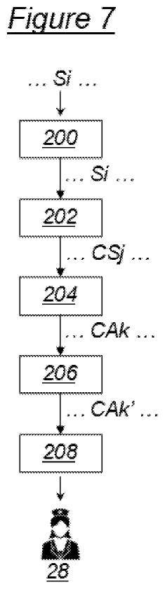

The slightly different operation of the remote monitoring server 18 shown in FIG. 5 will now be described in detail with reference to FIG. 7.

During a first reception step 200, which is performed at every instant t, that is, continuously, the interface 40 of the remote monitoring server 18 receives all sound samples Si provided by the acoustic sensors of the communicating devices C1, . . . , CN after processing by the local computers.

During a deduplication step 202 executed continuously and in parallel with step 200, the second deduplication functional module 62 processes the sound samples Si to generate the consolidated sound samples CSj, by successively executing the computer programs 52, 54, and 56. This deduplication 202 involves grouping at least some of the sound samples Si based on at least one of the sound similarity criteria mentioned previously, so as to form a reduced number of group(s) of sound samples, and then determining a consolidated sound sample for each formed group.

In a subsequent analysis step 204, the first analysis functional module 60 processes the consolidated sound samples CSj to generate the consolidated alerts CAk by executing the computer programs 48 and 50.

In a subsequent optional muting step 206, the consolidated CAk alerts are processed by executing the computer program 58 to generate the consolidated and confirmed CAk′ alerts.

Finally, during a transmission step 208, the consolidated and confirmed alerts CAk′ are transmitted to the automatic transmission interface 66 of the remote monitoring server 18, so that each of these consolidated and confirmed alerts CAk′ can be sent to a pre-registered terminal of a user capable of responding, for example a member of the response team 28, and to trigger an alarm (audible, visual, via messaging, etc.) or a response. As mentioned earlier, alternatively, all consolidated alerts CAk can be sent, wherein those that have not been confirmed can be flagged as corresponding to a consolidated and confirmed alert that has already been reported and may even have already been addressed by another team member.

It clearly appears that an acoustic monitoring system such as the one described above can effectively prevent false-positive alerts without requiring overly complex processing methods.

It should also be noted that the invention is not limited to the embodiments described above. It will be apparent to those skilled in the art that various modifications may be made to the embodiments described above in light of the information disclosed herein. In the detailed description of the invention provided above, the terms used should not be interpreted as limiting the invention to the embodiments described herein, but should be interpreted as including all equivalents that those skilled in the art would foresee by applying their general knowledge to the implementation of the teaching that has just been disclosed to them.

The analyzer and the deduplication system, as described herein, are each implemented as specific, executable software functional modules running on the processing unit 44 of the remote computer 42. Each of these functional modules corresponds to a set of computer program instructions stored in the memory 46 and executable by the processing unit 44. The processing unit 44 may comprise one or more general-purpose processors, digital signal processors (DSPs), application-specific integrated circuits (ASICs), field-programmable gate arrays (FPGAs), or any combination thereof. The memory 46 may comprise one or more volatile memory units (e.g., RAM), non-volatile memory units (e.g., ROM, flash memory), or any combination thereof. It will be understood by those skilled in the art that the functions attributed to the analyzer and to the deduplication system throughout this disclosure are not abstract or conceptual operations, but are instead concrete computational operations performed by specific hardware executing specific stored instructions. Alternatively, at least some of the functions attributed to the analyzer and the deduplication system could be implemented, at least in part, in dedicated hardware logic, such as hardwired digital circuits or programmable logic devices, without departing from the scope of the present invention. In all cases, whether implemented in software executing on a general-purpose processor, in dedicated hardware logic, or in a combination thereof, the structure corresponding to the analyzer comprises at least the processing unit 44, the memory 46, and the instructions of computer programs 48 and 50 stored therein, and the structure corresponding to the deduplication system comprises at least the processing unit 44, the memory 46, and the instructions of computer programs 52, 54, and 56 stored therein. The processing unit 44, operating in conjunction with the memory 46 and the respective stored instructions, constitutes sufficient structure to perform all of the functions attributed to the analyzer and to the deduplication system, respectively, throughout this disclosure.

It will further be appreciated that the analyzer and the deduplication system, while presented as distinct functional modules 60 and 62 for clarity of exposition, may be implemented on the same physical hardware—namely the remote computer 42 comprising the processing unit 44 and the memory 46—and may share computational resources without departing from the scope of the present invention. The functional distinction between the analyzer and the deduplication system reflects a logical separation of operations: the analyzer is responsible for sound classification and alert generation, while the deduplication system is responsible for grouping sound samples or alerts based on sound similarity criteria and determining consolidated outputs therefrom. This logical separation is supported throughout the specification and illustrated in FIGS. 4 and 5, which show the respective functional modules 60 and 62 and their interactions within the remote monitoring server 18. The structure corresponding to each functional module is fully disclosed in the specification such that a person of ordinary skill in the art would be able to implement each module without undue experimentation.

The present invention provides concrete and tangible improvements to acoustic monitoring technology and is directed to a specific practical application, namely the real-time monitoring of vulnerable and/or elderly individuals in collective residential facilities, with the specific technical goal of reducing false-positive alerts caused by spatial, temporal, and spatiotemporal acoustic ambiguities. The invention achieves this practical result through a specific technical implementation: the deduplication system, executing on the processing unit 44, operates on sound samples or alerts by applying defined sound similarity criteria—including spectral proximity in terms of spectral envelopes, characteristic frequencies, and frequency amplitudes, as well as temporal proximity in terms of temporal envelopes, temporal amplitudes, and duration—within defined time windows, to group redundant sound samples or alerts and determine a single consolidated output for each group. This is not an abstract idea or a mere mathematical concept applied in a vacuum, but a concrete technical solution implemented on specific hardware (the remote computer 42 comprising the processing unit 44 and the memory 46) and integrated into a specific system architecture (the remote monitoring server 18 communicating with a plurality of communicating devices C1, . . . , CN distributed throughout an area to be monitored Z).

The practical benefits of the present invention are directly tied to the technical implementation described herein. First, the deduplication system reduces or eliminates redundant alerts caused by the propagation of a single sound event across multiple acoustic sensors located in distinct locations within the area to be monitored Z, thereby reducing the number of unnecessary or untimely interventions by the response team 28 without requiring the installation of complex distributed microphone arrays as taught in the prior art. Second, the deduplication system reduces or eliminates redundant alerts caused by the temporal repetition of the same sound event captured by a single acoustic sensor, thereby preventing the same acoustic event from triggering multiple independent responses over time. Third, the combination of the analyzer and the deduplication system within the remote monitoring server 18 provides a scalable, hardware-efficient architecture in which a single remote computer 42 can serve multiple communicating devices distributed across one or more residential facilities, while maintaining the reliability and responsiveness required for real-time safety monitoring. Fourth, as illustrated in the embodiment of FIG. 5, placing the deduplication system upstream of the analyzer reduces the computational load on the analyzer by providing it with a reduced, non-redundant set of consolidated sound samples, thereby improving the overall efficiency of the acoustic monitoring system. These practical benefits flow directly and necessarily from the specific technical features of the claimed invention and confirm that the invention is directed to a concrete improvement in acoustic monitoring technology, and not to an abstract idea.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

A person skilled in the art will readily appreciate that various features, elements, parameters disclosed in the description may be modified and that various embodiments disclosed may be combined without departing from the scope of the invention. For example, various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having described above several aspects of at least one embodiment, it is to be appreciated various alterations, modifications, and improvements will readily occur to those skilled in the art. Such alterations, modifications, and improvements are intended to be aspects of this disclosure. Accordingly, the foregoing description and drawings are by way of example only.

1. An acoustic monitoring system comprising:
an interface for receiving a plurality of sound samples provided by at least one acoustic sensor located in an area to be monitored;
an analyzer configured to for analyze sound samples to generate alerts, and a deduplication system configured to:
group at least some of the sound samples received or alerts generated by the analyzer based on at least one criterion of sound similarity, so as to create a reduced number of group(s) of sound samples or alerts;
determine a consolidated sound sample or a consolidated alert for each group created.

2. The acoustic monitoring system as claimed in claim 1, further comprising:
said at least one acoustic sensor located in the area to be monitored; and/or an interface for automatically transmitting each alert generated from a consolidated sound sample or each consolidated alert to a pre-registered terminal belonging to a user authorized to intervene.

3. The acoustic monitoring system as claimed in claim 1, wherein the deduplication system is configured to:
group together multiple sound samples or multiple alerts from multiple acoustic sensors respectively located in multiple distinct locations within the area to be monitored, into a single group of sound samples or alerts, when said sound samples or alerts further fall within the same predetermined first time window, for example a first time window of 10 to 20 seconds; and
determine the consolidated sound sample or consolidated alert by selecting, from each created group, the sound sample or alert with the highest sound level, classification confidence score, or signal-to-noise ratio.

4. The acoustic monitoring system as claimed in claim 1, wherein the deduplication system is configured to, when multiple sound samples or multiple alerts originating from a single acoustic sensor among said at least one acoustic sensor are grouped together in a single group created within a second predetermined time window, to exclude from the determination of the consolidated sound sample or the consolidated alert of that group any sound sample or alert other than the one emitted first from the said single acoustic sensor.

5. The acoustic monitoring system as claimed in claim 1, wherein the at least one criterion of sound similarity applied by the deduplication system comprises at least one element from the set consisting of:
spectral proximity between sound samples in terms of spectral envelopes;
spectral proximity between sound samples in terms of characteristic frequencies;
spectral proximity between sound samples in terms of frequency amplitudes;
temporal proximity between sound samples in terms of temporal envelopes;
temporal proximity between sound samples in terms of temporal amplitudes; and
temporal proximity between sound samples in terms of duration.

6. The acoustic monitoring system as claimed in claim 1, comprising additional systems configured to suppress at least one alert derived from a consolidated sound sample or at least one consolidated alert, such suppression resulting from the application of predetermined rules and/or machine learning.

7. The acoustic monitoring system as claimed in claim 1, wherein the deduplication system is configured to:
group at least some of the received sound samples based on the at least one criterion of sound similarity, so as to create a number of group(s) of sound samples that is less than the number of received sound samples;
determine a consolidated sound sample for each group created; and
supply each consolidated sound sample to the analyzer rather than each received sound sample.

8. The acoustic monitoring system as claimed in claim 1, designed to supply all received sound samples to the analyzer, and wherein the deduplication system is configured to:
group at least some of the alerts generated by the analyzer based on the at least one criterion of sound similarity, this criterion of sound similarity relating to the analyzed sound samples generating the alerts, so as to create a reduced number of alert group(s);
determine a consolidated alert for each group created.

9. The acoustic monitoring system as claimed in claim 1, for N acoustic sensors C1, . . . , CN located in the area to be monitored, comprising a system configured to store in memory of an acoustic proximity matrix AP, each matrix coefficient AP_{m,n} of which, where 1≤m≤N and 1≤n≤N, comprises at least one probability value that at least one predetermined sound emitted in the vicinity of the acoustic sensor Cm and mainly detected by it is also detected by the acoustic sensor Cn, the deduplication system being designed to use this acoustic proximity matrix AP to exclude from sound similarity computations certain pairs of acoustic sensors deemed too far apart from one another based on the corresponding matrix coefficient.

10. An acoustic monitoring method comprising:
receiving a plurality of sound samples provided by at least one acoustic sensor located in an area to be monitored;
generation, by an analyzer for analyzing sound samples of an acoustic monitoring system, of alerts resulting from at least some of the sound samples that they receive;
grouping, by a deduplication system of the acoustic monitoring system, of at least some of the received sound samples or the alerts generated by the analyzer based on at least one criterion of sound similarity, so as to create a reduced number of group(s) of sound samples or alerts;
determination, by the deduplication system, of a consolidated sound sample or a consolidated alert for each group created.

11. A non-transitory computer-readable medium comprising instructions for performing the steps of an acoustic monitoring method as claimed in claim 10, when said instructions are executed by at least one computer of an acoustic monitoring system.
